(19) United States
(12) Patent Application Publication
(10) Pub. No.: US 2011/0093322 A1
(43) Pub. Date: Apr. 21, 2011

(54) System and method for substituting one email address for another to redirect a reward payment

(76) Inventor: Tabbatha Christie Lawe, Immokalee, FL (US)

(21) Appl. No.: 12/798,210

(22) Filed: Mar. 31, 2010

Related U.S. Application Data
(60) Provisional application No. 61/212,139, filed on Apr. 9, 2009.

(51) Int. Cl. G06Q 30/00

(52) U.S. Cl. 705/14.23; 705/14.39

(57) ABSTRACT

A system and method to allow a buyer to substitute one email address for another to redirect a reward payment tied to the substituted email. A buyer's email address is captured in an online transaction record. A system reward email message announcing a pending reward based on the transaction is then sent to the buyer's original transaction email address. The reward email message contains a link to allow the email recipient to open a web page form and self-substitute another email address associated with a financial account to subsequently receive the pending reward payment to that financial account. Upon entering the substitute email address, the system marks the buyer's account so any reward is paid to the substitute email address associated with the a financial account.

### BACKGROUND OF THE INVENTION

1. Field of the Invention

This invention relates generally to systems and methods for allowing the automated substitution of one email address tied to a financial account at a non-traditional payment service in place of another email address registered during a purchase transaction so the seller in the purchase transaction can redirect a cash payment to reward the purchaser via a non-traditional payment service.

2. Background Of The Invention

Nearly all online purchase transactions require a buyer to enter an email account to be recorded with, and associated to, the buyer's online purchase transaction record and to make an online payment for the purchase via a payment method of the buyer's choice.

The entered email address is a byproduct of the transaction and is subsequently used to provide information to the email addressee regarding the transaction such as shipment information and confirmation of orders.

Approximately 85% of all online purchases are selected to be paid by buyers using a credit card payment service where the buyer enters a credit card number and associated information to complete the purchase payment. The remaining approximately 15% of payments are made through a non-traditional payment services such as a money transmittal services like PayPal, Amazon Flexible Payments Services, Revolution Money or similar such non-traditional payment services. These non-traditional payment services allow a buyer to separately establish the buyer's own non-traditional payment service account. The established non-traditional payment account can then be used by the buyer as an alternative form of payment at the time of an online transaction purchase.

Generally, the non-traditional payment account includes a process where the registering buyer must enter an email address. In many instances, the buyer's email address is then the primary identifier for the buyer's non-traditional payment account.

In addition to allowing for payments between online buyers and sellers, non-traditional payment services also allow one user to send money to another user on the same service by simply identifying the recipient's email account and sending the payment amount. Therefore, by having the email address of another person's account at a non-traditional payment service, a sender can utilize the non-traditional payment service to easily send a payment from the user's account to the target payment account.

Moreover, the method of sending and receiving a payment, and particularly a low value payment, between a sender and a receiver on a non-traditional payment service is often significantly less costly than a similar payment made via a traditional bank account or via processing a payment transfer through a credit card. A traditional credit card account will often charge a per transaction fee of $0.10 to $0.60 as well as a 2-5% fee of a transfer made between a sender and receiver. Alternatively, the non-traditional payment services will allow a sender to send money to a receiver on the same payment service for a much lower cost, such as only 2% of the payment. For example, a $1.00 payment made between a sender and a receiver on a credit card payment service could cost the receiver as much as $0.60 for the transaction plus $0.05 of the sent $1.00. Thus, the receiver would lose $0.65 in value and would receive only $0.35 instead of the $1.00.

The same $1.00 transfer made between a sender and a receiver on a non-traditional payment service could cost the receiver nothing and could cost the sender only $0.02. Thus, the receiver would pay nothing and receive the full $1.00.

Given this cost disparity to receive money, any retailer who wishes to send a payment to a buyer, such as a cash reward for purchases, would generate significantly more value to a targeted buyer by using a non-traditional payment service to send a payment to the buyer if the retailer has the buyer's email address at the non-traditional payment service.

Unfortunately, buyers often have multiple email addresses and it is highly likely that a retailer will not have the targeted buyer's non-traditional payment service email address identifier if the buyer paid for a purchase with a credit card. Given that approximately 85% of all online payments are made with a credit card, the challenge for an online retailer issuing a payment back to a buyer is to ultimately get the email associated with the buyer's non-traditional payment service email account to be able to send any reward transfer payment at the best value to the buyer.

This challenge is met if the seller can get the buyer's email for an account on a non-traditional payment service.

Thus, the requirement is clear for a method and system to allow a targeted buyer with a means to substitute the buyer's non-traditional payment service email address identifier for the one possibly used during a purchase transaction so the buyer can receive a transfer payment, such as a reward, from the retailer at the highest value to the buyer.

The fact is many buyers use multiple email addresses to manage their level of interaction with the recipient of each email address. For instance, many buyers will register one email address while making an online purchase, knowing that the seller of the purchased item or service might contact them with other offers. In a different circumstance, such as interacting with friends and family, the buyer may give another, different email address. Yet again, the buyer might have still another unique email address only to track, send or receive payments on a non-traditional payment service.

In the above scenario the buyer would have three distinct email addresses with no recipient of any one of the email addresses being aware of the other email addresses for the buyer/person.

### Objects and Advantages

Accordingly, several objects and advantages of my invention are providing any number, or type, of online sellers to operate a simple, readily understandable, low-cost email substitution method and system to notify buyers of a pending reward via an email sent to a registered transaction purchase email address and to allow the buyer receiving the email to substitute another email address tied to a non-traditional payment service, so the online retailer can redirect the buyer's reward to the substituted email account at the non-traditional payment service thereby providing the buyer with greater reward value.

### SUMMARY OF THE INVENTION

The preferred embodiments of the present invention provide a system and method for an email substitution system to notify buyers of a pending reward via an automatically generated email sent to the email address the buyer registered during a purchase transaction. The email includes an HTML link to allow the buyer to automatically open a form web page to substitute a different email address than the one used on the generated email in order to redirect a pending reward to a non-traditional payment service account associated with the substituted email.

To begin, the buyer's online transaction information, including the registered email address and any other associated related transaction information, is received and stored by the substitution system. The substitution system next generates and sends the buyer a pending reward email invitation to the buyer's recorded transaction email address. The pending reward email invitation is generated automatically by the system and includes text informing the buyer that a pending reward will be paid to the buyer for the rewards program.

The email will also include an unique embedded HTML link and standard associated text informing the buyer of receiving a reward. By clicking the link, the buyer's browser will open a form web page where the buyer can substitute another email address registered at a non-traditional payment service to redirect the reward deposit to the substituted account.

If the buyer does not click the embedded HTML link, the system provides no further services and waits for the next stored transaction information.

If the buyer does click the embedded HTML link, the system will receive the click notification and open a form web page on the system within the buyer's browser.

The form web page will include the original transaction email address where the pending reward email was sent or alternatively will allow the buyer to enter the original email address. The form will also include an input box where the buyer can substitute the buyer's own choice of an email address at a participating non-traditional payment service.

The form web page will also include a confirmation button and related text explaining to the buyer that upon entering the substituted email and pressing the confirmation link, a confirmation email will be sent to the substituted chosen email address with an embedded HTML link that must be clicked by the recipient to confirm and complete the automated substitution of the entered email address.

Upon clicking the confirmation button on the form web page, the system will create and send the confirmation email to the substituted chosen email. The confirmation email will include text confirming the substitution of the non-traditional payment service email for the original transaction email has been received and the text will further indicate the buyer may click an embedded confirmation HTML link also included included in the confirmation email, to complete the substitution process.

Upon clicking the confirmation link, a new web page will open in the buyer's web browser informing the buyer that the substitution has been completed and the pending reward will be redirected to the substituted email address via the non-traditional payment service. The system will then wait for the next transaction information record.

### BRIEF DESCRIPTION OF THE DRAWINGS

These and other features and advantages of the invention will now be described with reference to the drawings of certain preferred embodiments, which are intended to illustrate and not to limit the invention, and in which:

FIG. 1 is a high-level architectural drawing illustrating the primary components of a system for substituting one email address for another to receive a reward payment.

FIG. 2 is a block flow diagram illustrating the method in accordance with the invention.

FIG. 3 is a diagram of information for a buyer transaction record for use with one embodiment of the present invention

FIG. 4 is a sample of a pending reward email invitation created and sent by the system to the buyer.

FIG. 5 is a sample form web page providing the buyer with an input form to substitute an email for the existing email.

FIG. 6 is sample confirmation email sent from the system to the buyer.

### DETAILED DESCRIPTION OF THE PREFERRED EMBODIMENT

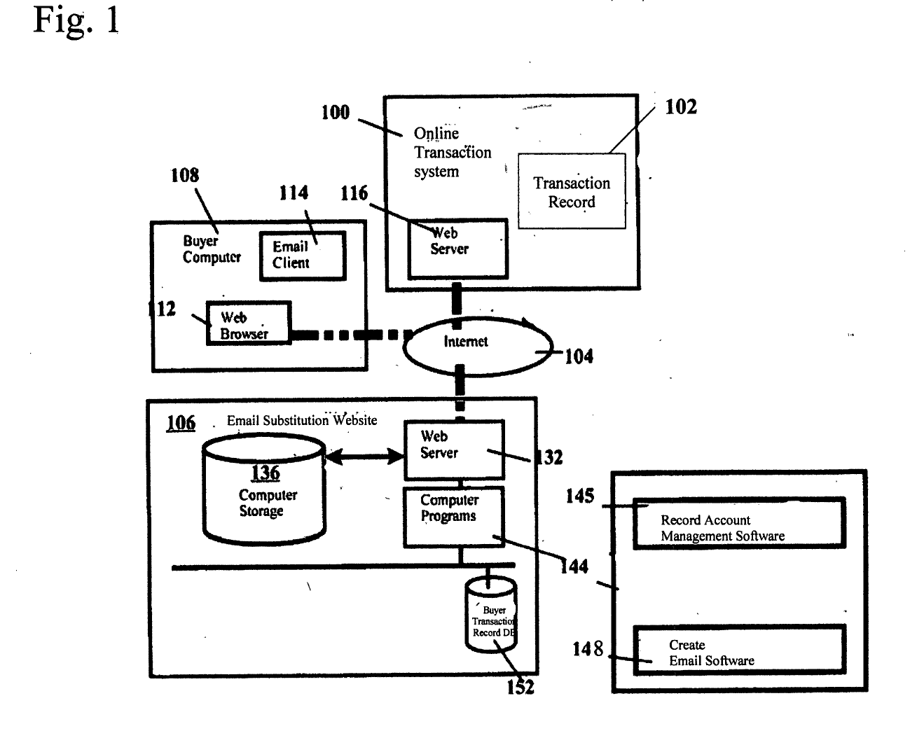

FIG. 1 is a high-level architectural drawing illustrating the primary components of a system for substituting one email address for another to redirect a buyer reward. The email substitution system includes an Online Transaction System 100 capable of producing an Online Buyer Transaction Recored 102, an email substitution web site 106, a buyer computer 108, all of which are linked together by the Internet 104.

The buyer computer 108 may be any type of computing device that allows the buyer to receive and respond to emails via an email client 114 and interactively browse Web sites via a Web browser 112. For example, the buyer computer 108 may be a personal computer (PC) that runs the Windows Vista operating system and Fire Fox Browser and which can access an email service. Alternatively, this device could be a mobile phone operating a browser.

The preferred embodiment of this invention is a system and method for use with the Internet 104, a widely known global computer network. This invention is, however, not limited to the Internet. Thus, as used herein, the term “network” refers to any distributed computer network whether it be a local area network (LAN), a wide area network (WAN), or an Intranet.

The Online Transaction System 100 is an online web site system which allows a buyer and seller to transact. The Buyer Transaction Record 102 is a record of a buyer's online transaction with the seller and includes at a minimum the buyer's email address. In addition to the email address, in the preferred embodiment of the invention the Buyer Transaction Record 102 used in the system contains the buyer's item(s) purchased, purchase amount, date and time of purchase, payment method, buyer name, address, phone and any other relevant transaction information.

The email substitution web site 106 advantageously includes a web server 132 and computer storage 136, a buyer transaction record database 152, and multiple computer software programs 144.

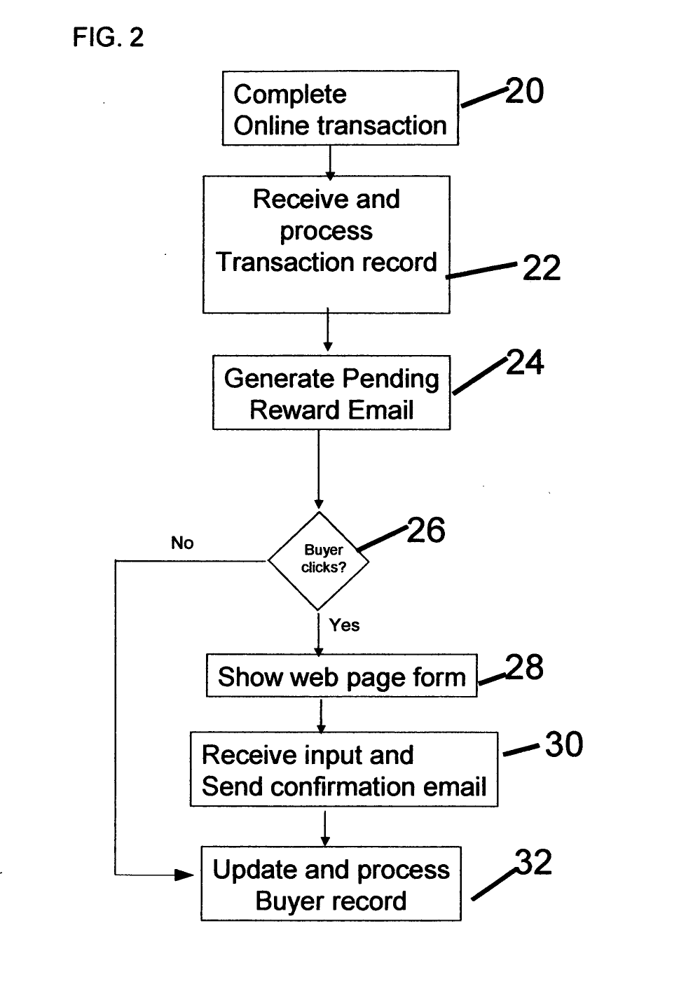

FIG. 2 is a general flow diagram of the method of this invention. Referring to this figure, completion of an online transaction record is initiated at Step 20. Completion of an online transaction record occurs after a transaction is completed by a buyer at the seller's online transaction system 100. At the conclusion of the online transaction, an online buyer transaction record 102 is created. The online buyer transaction record 102 must include the buyer's email and may include the buyer's item(s) purchased, purchase amount, date and time of purchase, payment method, buyer name, address, phone, seller online transaction system name and any other relevant transaction information. The online buyer transaction record is sent over the internet 104 to the email substitution web site 106.

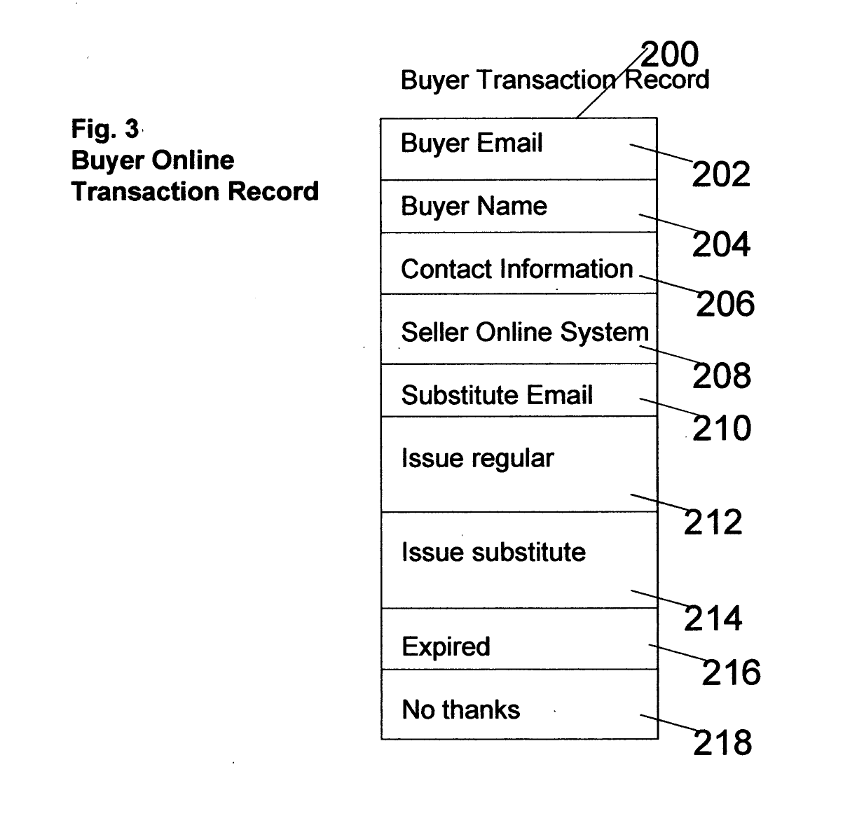

Next, at step 22, the online buyer transaction record 102 is received and processed at the email substitute web site 106. The processing includes receiving the online buyer transaction record 102 at the web server 132 on the email substitution web site 106 by the Record Account Management Software 145. The record account management software appends the newly received record by appending several fields to the record including a substitute email field as shown in FIG. 3, (210), an issue regular field 212, an issue substitute field 214 and an expire field 216, to the buyer transaction record and stores the buyer transaction record (FIG. 3) on the Buyer Transaction Record DB 152. When all of the fields 210, 212, 214 or 216 are appended, the system moves to step 24.

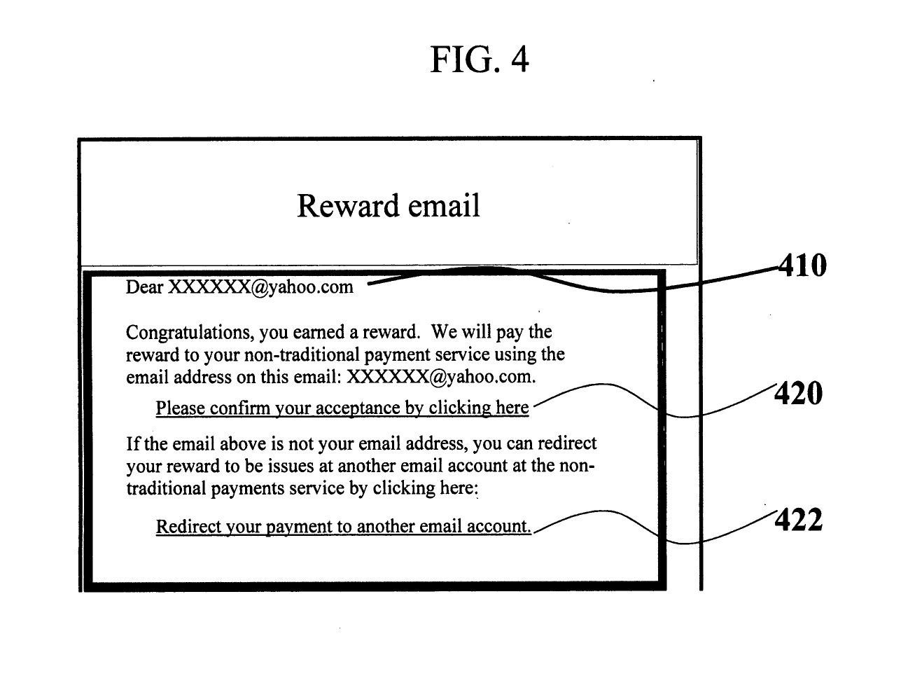

At step 24, the system generates the reward email (FIG. 4). Referring to FIG. 4, the email is sent to the buyer's original email address (410) as recorded in the buyer's online transaction record FIG. 3 in the email field 202. The text includes notification of the pending reward and further instructs the buyer that the reward will be paid if the buyer clicks the “issue reward” embedded HTML link (420). Alternatively, the email can notify the buyer the reward will automatically be deposited to the buyer's original email address unless the buyer clicks the substitute email embedded HTML link 422 to redirect the reward payment to a substituted email address.

At step 26, the buyer either clicks the substitute email embedded HTML link 422 or does nothing.

At step 26, if the buyer does anything other than click the substitute email embedded HTML link 422, then after a predetermined time such as 7 days, the system moves to step 32 to update the buyer transaction record 200 using the Record Account Management Software 145. In one embodiment, doing nothing indicates the system should send the reward using the original email address used for the email as the non-traditional payment service account.

If, at step 26, the buyer clicks the substitute email embedded HTML, link 422, the system moves to step 28.

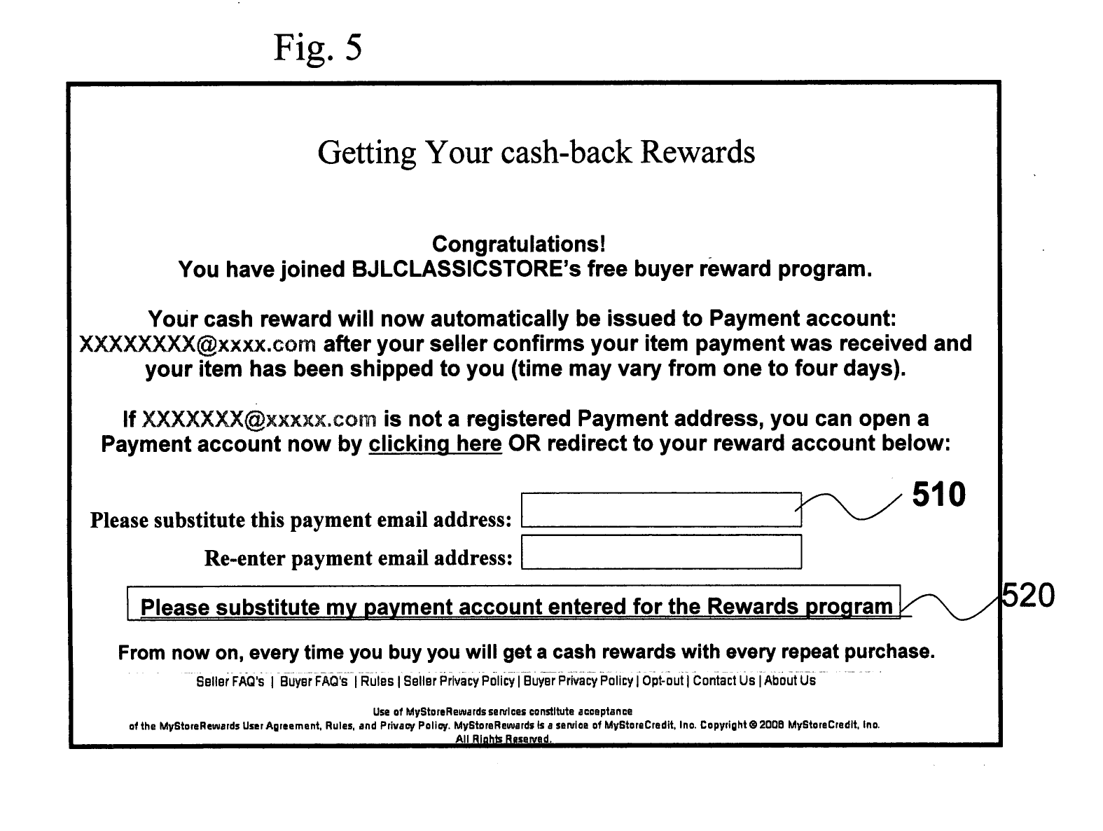

At step 28, the buyer's browser 112 records the buyer's click and initiates the buyer's browser 112 by presenting a custom form web page FIG. 5 to be presented in the buyer's browser 112.

Referring to FIG. 5, the buyer's existing email address is presented on the form web page and text is provided explaining the process of substituting the email address.

The buyer is presented with an input box (FIG. 5 510) where the buyer can enter their choice of substitute email address. In one embodiment of the invention, the buyer could also substitute an email address from a presented list, such as an email address associated with a non-profit organization. In this way, the buyer could effectively re- direct the reward payment to the non-profit organization.

Upon entering the substitute email address, the buyer clicks the confirm change of email button (520).

Upon the buyer clicking the confirm change email button 520, the system moves to step 30.

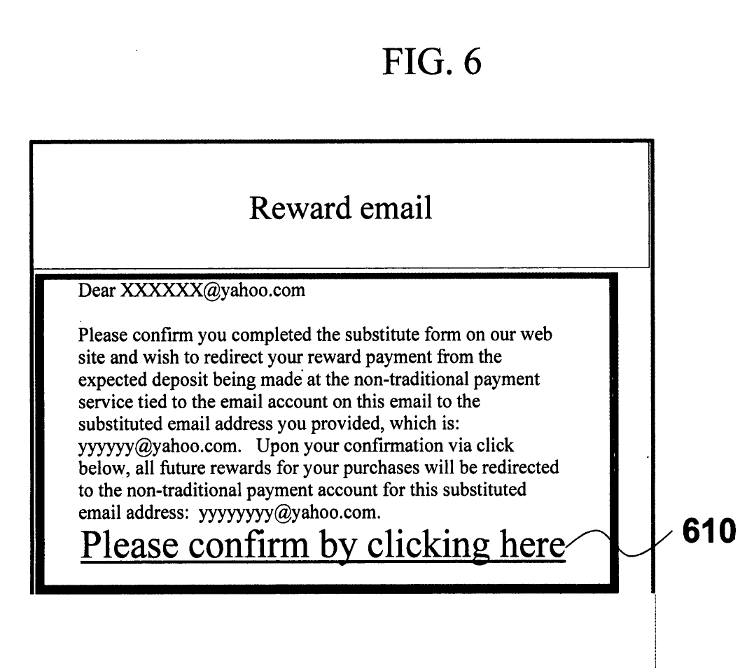

At step 30, the email substitution web site 106 creates a confirmation email using the create email software program 148. A sample confirmation email is shown in FIG. 6.

Referring to FIG. 6, the confirmation email is sent to the original email address and explains the newly substituted email will be used to make the reward payment once the buyer clicks the confirm change of email embedded HTML link 610. In one embodiment of the invention, step 30 could be skipped and the presumption that the substituted email is to be used for the redirection of the reward payment.

Upon the Email Substitution Website 106 web server 132 receiving the buyer's click of the confirm change of email embedded HTML link confirming the substitution as explained in the confirmation email (FIG. 6) the system moves to step 32.

At step 32, the buyer's transaction record is processed using the Record account management software 145 and the substitute email field 210 and the issue substitute reward field 214 are updated so that the future reward, when issued, will be redirected to the substituted email account.

It will be appreciated by those skilled in the art that numerous modifications and variations are possible, and that the invention may be practiced otherwise than as specifically described herein, without departing from the scope thereof.

I claim:

1. An email substitution system for redirecting a reward payment to a substitute email address between a seller and a buyer, involving an online transaction system, a buyer computer, an email substitution website connected via a network, said email substitution system configured to:
(a) implement a process for said email substitution website to send a loyalty reward notification email with HTML link to said buyer,
(b) receive and record said buyer's click on said HTML link from said loyalty reward notification email,
(c) present a web page form in response to said click;
(d) accept and record said buyer's substitute email address on said web page form to redirect a reward payment to the substituted email address.

2. The system of claim 1 wherein the substituted email address is chosen by said buyer on the web page form, from a list of non-profit organization email addresses.

3. An automated method, performed by a computer-based email substitution system, for redirecting a reward payment to a substitute email address, the method comprising: creating and presenting a reward email with HTML link, accepting and recording the buyer's click of said HTML link in said reward email and presenting a web form to allow the substitution of an email address to redirect a reward payment to the substituted email address.

4. The method of claim 3, wherein the presenting of a web form provides options for selecting an existing email address from a list of non-profit organization email addresses.
